(19) United States
(12) Patent Application Publication
(10) Pub. No.: US 2024/0329352 A1
(43) Pub. Date: Oct. 3, 2024

(54) IMAGE PICKUP LENS, CAMERA MODULE, AND METHOD FOR PRODUCING IMAGE PICKUP LENS

(71) Applicants: Sharp Sensing Technology Corporation, Tenri City (JP); KANTATSU Co., LTD., Tokyo (JP)

(72) Inventors: Yuhichi IESHIMA, Tenri City (JP); Kohji MOTOTAMA, Tenri City (JP); Yasuaki ISOBE, Tenri City (JP); Fumihiro NISHIO, Tenri City (JP); Shohnosuke UENO, Tenri City (JP); Masaki SHIDARA, Tokyo (JP)

(21) Appl. No.: 18/581,487

(22) Filed: Feb. 20, 2024

(30) Foreign Application Priority Data
Mar. 27, 2023 (JP) 2023-050524

(51) Int. Cl. G02B 7/02; G02B 13/00

(52) U.S. Cl. CPC G02B 7/021; G02B 13/0045

(57) ABSTRACT

An image pickup lens having high reliability is realized. The image pickup lens includes a substrate holding member that holds a flexible substrate. The substrate holding member is fixed with respect to a first surface. The substrate holding member has an opening which is formed therein and in which a polymer lens and a connection part are located in a plan view.

This Nonprovisional application claims priority under 35 U.S.C. § 119 on Patent Application No. 2023-050524 filed in Japan on Mar. 27, 2023, the entire contents of which are hereby incorporated by reference.

### TECHNICAL FIELD

The present disclosure relates to an image pickup lens, a camera module, and a method for producing an image pickup lens.

### BACKGROUND ART

There is known an image pickup lens in which a polymer lens and a substrate are electrically connected to each other. As a technique similar to such an image pickup lens, Patent Literature 1 discloses a configuration in which a printed circuit board (PCB) and a terminal unit of an actuator having a variable lens are electrically connected to each other.

### CITATION LIST

### Patent Literature

### [Patent Literature 1]

Specification of U.S. Pat. No. 9,297,978

### SUMMARY OF INVENTION

### Technical Problem

It is conceivable to use a flexible substrate as the substrate. In an image pickup lens in which a polymer lens and a flexible substrate are electrically connected to each other, there is a risk that a connection part electrically connecting the flexible substrate and the polymer lens may come off from the flexible substrate and/or the polymer lens due to flection of the flexible substrate. Thus, the image pickup lens has low reliability.

### Solution to Problem

An image pickup lens in accordance with an aspect of the present disclosure includes: a flexible substrate having a first surface; a polymer lens provided with respect to the first surface; a connection part electrically connecting the flexible substrate and the polymer lens; and a substrate holding member holding the flexible substrate, the substrate holding member being fixed with respect to the first surface, the substrate holding member having an opening which is formed therein and in which the polymer lens and the connection part are located in a plan view.

### Advantageous Effects of Invention

According to an aspect of the present disclosure, it is possible to realize an image pickup lens having high reliability.

### BRIEF DESCRIPTION OF DRAWINGS

FIG. 1 is a cross-sectional view schematically illustrating configurations of a camera module and an image pickup lens in accordance with Embodiment 1 of the present disclosure.

FIG. 2 is a perspective view of the camera module in accordance with Embodiment 1 of the present disclosure.

FIG. 3 is a perspective view illustrating a flexible substrate, a polymer lens, and a connection part in the image pickup lens in accordance with Embodiment 1 of the present disclosure.

FIG. 4 is a perspective view illustrating a flexible substrate, a polymer lens, a connection part, and a substrate holding member in the image pickup lens in accordance with Embodiment 1 of the present disclosure.

FIG. 5 is a flowchart illustrating a method for producing the image pickup lens in accordance with Embodiment 1 of the present disclosure.

FIG. 6 is a perspective view illustrating a flexible substrate, a polymer lens, a substrate holding member, and a lens cover in accordance with Embodiment 2 of the present disclosure.

FIG. 7 is an exploded perspective view of an image pickup lens in accordance with Embodiment 2 of the present disclosure.

FIG. 8 is three perspective views each schematically illustrating a configuration of a substrate holding member-cum-lens cover in accordance with Embodiment 3 of the present disclosure.

### DESCRIPTION OF EMBODIMENTS

The following will describe embodiments for carrying out the present disclosure. For convenience of description, any members having functions identical to those of members described earlier may be given respective identical reference signs and may not be described again.

### Embodiment 1

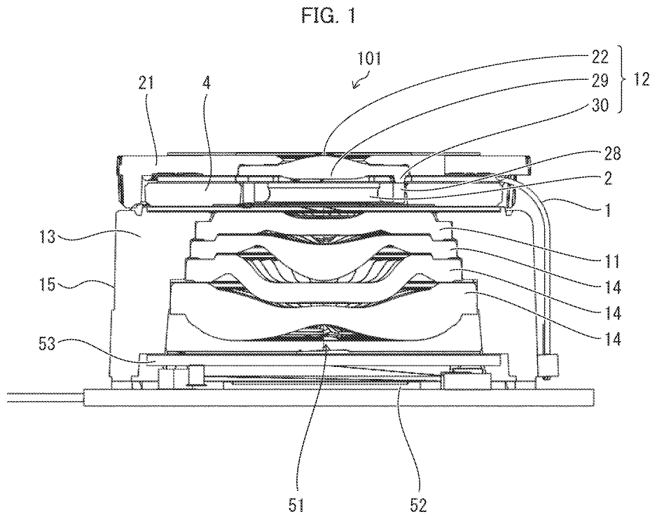

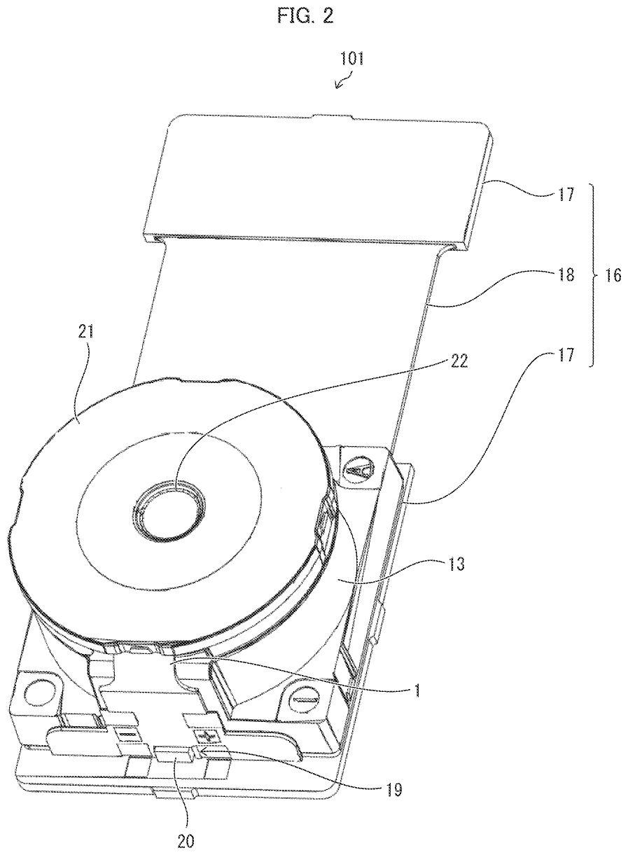

FIG. 1 is a cross-sectional view schematically illustrating configurations of a camera module 101 and an image pickup lens 51 in accordance with Embodiment 1 of the present disclosure. FIG. 2 is a perspective view of the camera module 101. The camera module 101 includes the image pickup lens 51 and an image pickup element 52 that receives light having passed through the image pickup lens 51.

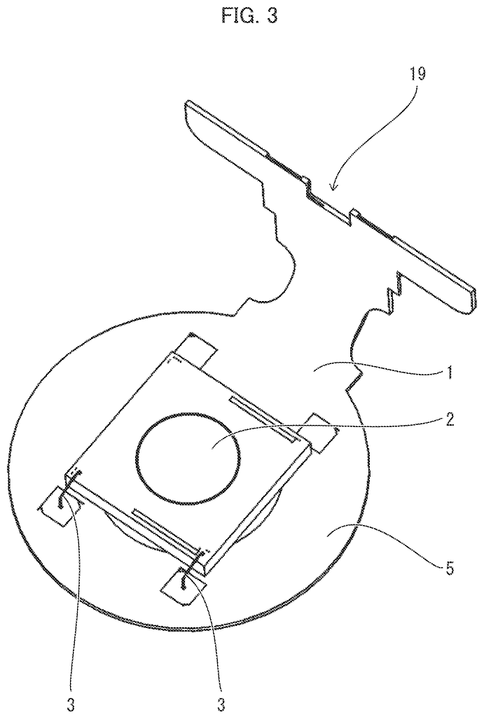

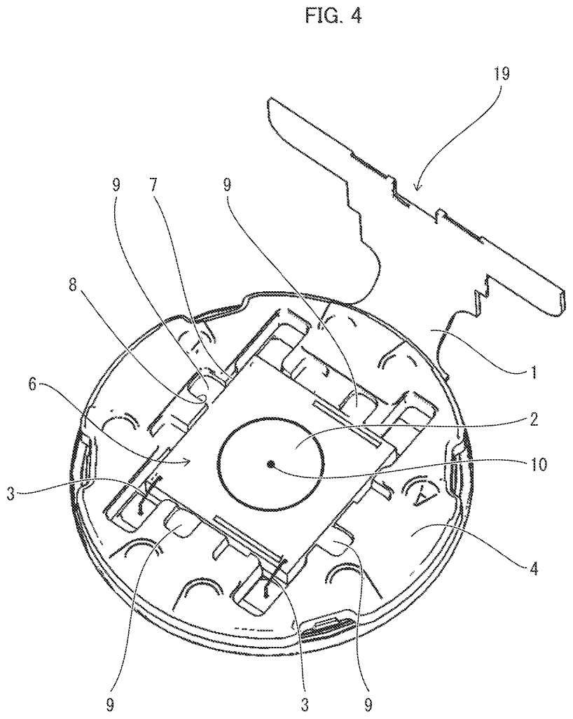

FIG. 3 is a perspective view illustrating a flexible substrate 1, a polymer lens 2, and a connection part 3 in the image pickup lens 51. FIG. 4 is a perspective view illustrating the flexible substrate 1, the polymer lens 2, the connection part 3, and a substrate holding member 4 in the image pickup lens 51. The image pickup lens 51 includes the flexible substrate 1, the polymer lens 2, the connection part 3, and the substrate holding member 4.

The flexible substrate 1 has a first surface 5. The polymer lens 2 is provided with respect to the first surface 5. The connection part 3 electrically connects the flexible substrate 1 and the polymer lens 2. The substrate holding member 4 holds the flexible substrate 1. The connection part 3 may be one selected from the group consisting of a bonding wire and an electrically conducive paste. This makes it possible to easily realize the connection part 3. In the present embodiment, the connection part 3 is a bonding wire. The first surface 5 can be rephrased as a lens-mounting surface of the flexible substrate 1.

The substrate holding member 4 is fixed with respect to the first surface 5. The substrate holding member 4 has an opening 6 formed therein. The polymer lens 2 and the connection part 3 are located in the opening 6 in a plan view of the image pickup lens 51.

According to the image pickup lens 51, in a case where the flexible substrate 1 and the polymer lens 2 are electrically connected to each other, the substrate holding member 4 holds the flexible substrate 1. Thus, it is possible to reduce the risk that the connection part 3 may come off from the flexible substrate 1 or the polymer lens 2 due to flection of the flexible substrate 1. Therefore, it is possible to realize the image pickup lens 51 having high reliability.

The substrate holding member 4 may contain a resin. This makes it possible to easily realize the substrate holding member 4. The resin contained in the substrate holding member 4 may be a liquid crystal polymer (LCP). This makes it possible to impart excellent heat resistance to the substrate holding member 4. For example, in a case where the flexible substrate 1 and the polymer lens 2 are electrically connected to each other after the substrate holding member 4 has been fixed with respect to the first surface 5, it is possible to reduce the risk of deformation of the substrate holding member 4. The resin contained in the substrate holding member 4 is not limited to a liquid crystal polymer and may be, for example, polycarbonate.

A side wall 7 of the polymer lens 2 and an inner wall 8 which is of the substrate holding member 4 and which defines the opening 6 may be bonded to each other. This makes it possible to fix the polymer lens 2 and the substrate holding member 4. Thus, it is possible to realize the image pickup lens 51 having higher reliability.

The side wall 7 and the inner wall 8 may be bonded to each other at a plurality of bonding portions 9, and the plurality of bonding portions 9 may be located so as to be rotationally symmetric with respect to a center 10 of the polymer lens 2 in a plan view of the image pickup lens 51. This makes it possible to realize the image pickup lens 51 that is tolerant of a positional deviation of the polymer lens 2 in a direction of rotation of the polymer lens 2 in the plan view of the image pickup lens 51.

The image pickup lens 51 includes a first lens 11, a second lens 12, and a barrel 13. The first lens 11 is located at a position closer to an image-forming plane (an image plane) than the polymer lens 2. The second lens 12 is located at a position closer to an object (a subject) than the polymer lens 2. The position closer to the image-forming plane in the image pickup lens 51 can be rephrased as a position closer to an image pickup element 52 in the camera module 101. The image pickup lens 51 may include one or more third lenses 14 that are located at a position closer to the image-forming plane than the first lens 11. In FIG. 1, the number of the third lenses 14 is three. The lens barrel 13 accommodates the first lens 11.

The flexible substrate 1 and an outer wall 15 of the lens barrel 13 may be engaged with each other. This makes it possible to position the flexible substrate 1. Thus, it is possible to reduce the risk of assembly failure resulting from interference of the flexible substrate 1 with other member (e.g., a rigid flexible substrate 16) during the production of the camera module 101. A bending position of the flexible substrate 1 and a fixing position of the flexible substrate 1 to the lens barrel 13 become constant. This makes it possible to inhibit soldering failure between the flexible substrate 1 and the rigid flexible substrate 16 and assembly failure resulting from interference between the flexible substrate 1 and the rigid flexible substrate 16.

The rigid flexible substrate 16 is included in the camera module 101 and is connected to the flexible substrate 1. The rigid flexible substrate 16 includes: a rigid portion 17 that is suitable for connection and holding of various members and that is relatively rigid; and a flexible portion 18 having flexibility.

The outer wall 15 may have a projected part 20 that is fitted into a first missing part 19 which is formed in the flexible substrate 1. This makes it possible to easily realize an engagement structure between the flexible substrate 1 and the outer wall 15.

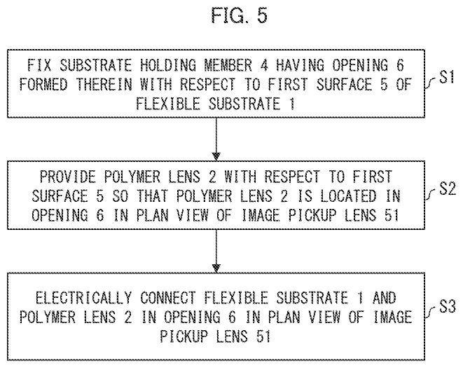

FIG. 5 is a flowchart illustrating a method for producing the image pickup lens 51. The method for producing the image pickup lens 51 includes steps S1 to S3. Step S1 is a step of fixing the substrate holding member 4 having the opening 6 formed therein with respect to the first surface 5 of the flexible substrate 1. Step S2 is a step of providing the polymer lens 2 with respect to the first surface 5 so that the polymer lens 2 is located in the opening 6 in the plan view of the image pickup lens 51. Step S3 is a step of electrically connecting the flexible substrate 1 and the polymer lens 2 in the opening 6 in the plan view of the image pickup lens 51.

Here, an example has been described in which the steps S1, S2, and S3 are carried out in this order, but the order in which the steps S1, S2, and S3 are carried out is not limited thereto. The steps S1, S2, and S3 may be carried out in any order, provided that the production of the image pickup lens 51 is possible.

A configuration may be employed in which the flexible substrate 1 and the polymer lens 2 are electrically connected to each other after the substrate holding member 4 containing a liquid crystal polymer has been formed and fixed with respect to the first surface 5. This makes it possible to reduce the risk of deformation of the substrate holding member 4 while the flexible substrate 1 is held by the substrate holding member 4 as quickly as possible.

A configuration may be employed in which the flexible substrate 1 is bent, and fixing of the first missing part 19 of the flexible substrate 1 is fixed to the projected part 20 of the outer wall 15 with, for example, a double-sided tape. The lens barrel 13 may be fixed to the rigid flexible substrate 16 with a resin.

The image pickup lens 51 may include a frame 28 located around an edge of the polymer lens 2. The second lens 12 may have a lens surface 29 that faces a center of the polymer lens 2 and an abutting portion 30 that is located on the rim of the lens surface 29 and that abuts on the frame 28. The camera module 101 may include a cover glass 53 that covers the image pickup element 52.

### Embodiment 2

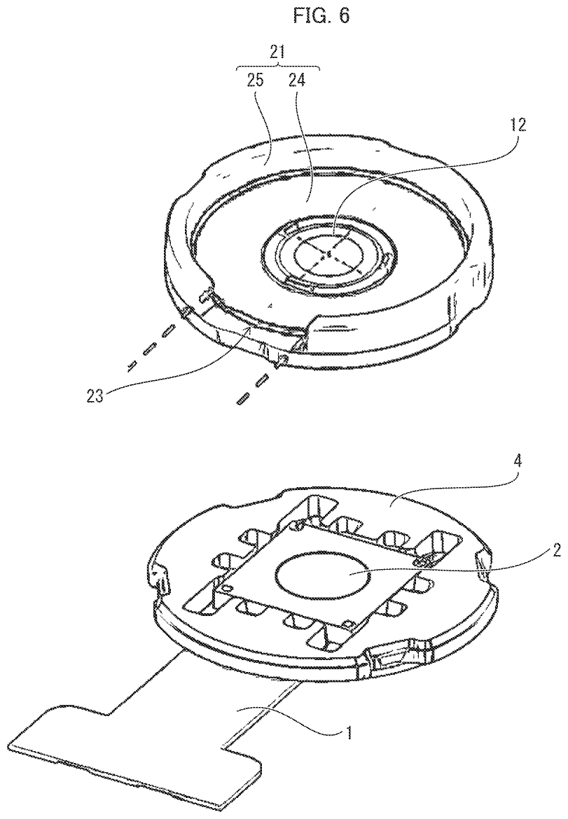

FIG. 6 is a perspective view illustrating a flexible substrate 1, a polymer lens 2, a substrate holding member 4, and a lens cover 21 in accordance with Embodiment 2 of the present disclosure. The image pickup lens 51 includes a lens cover 21.

A second lens 12 located at a position closer to an object than the polymer lens 2 has a lens surface 22 on a side thereof on which the object is present. The lens cover 21 covers an outer region of the lens surface 22. The flexible substrate 1 may be drawn from an inside of the lens cover 21 to an outside of the lens cover 21 in the plan view of the image pickup lens 51 at a second missing part 23 that is formed in the lens cover 21. This makes it possible to apply a voltage to the flexible substrate 1 in a state in which physical load on the flexible substrate 1 is small. Thus, it is possible to reduce the risk of deterioration in the optical characteristic resulting from deformation of the flexible substrate 1. Examples of the deterioration of the optical characteristic include light blocking by the flexible substrate 1 and difficulty in optical correction.

The lens cover 21 has a covering part 24 covering the outer region of the lens surface 22 and a wall part 25 extending from the covering part 24 toward an image-forming plane. The second missing part 23 may be formed in the wall part 25 and have an object-side end portion that is defined by the covering part 24. This does not form any step on the image-forming plane side of the covering part 24 (step formed by the object-side end portion of the second missing part 23). Thus, it is possible to further reduce physical load on the flexible substrate 1. The second missing part 23 having the object-side end portion that is defined by the covering part 24 can be rephrased as the second missing part 23 having the object-side end portion that is flush with an image-forming plane-side end portion of the covering part 24.

Various methods are conceivable for the application of a voltage to the polymer lens 2. The application of a voltage to the polymer lens 2 can be carried out in a configuration based on the premise that the polymer lens 2, the first lens 11, the second lens 12, and the third lenses 14 are aligned. The application of a voltage is carried out through the flexible substrate 1 from the polymer lens 2 fixed to the substrate holding member 4. Holding the second lens 12 with the lens cover 21 and forming the second missing part 23 in the lens cover 21 enable achievement of a configuration that does not affect light blocking and optical correction. In an add-in structure having a configuration in which a voltage is applied to the polymer lens 2, it is recommended that a distance between the second lens 12 and the polymer lens 2 and a distance between the polymer lens 2 and the first lens 11 be several tens of micrometers. Thus, wiring using the flexible substrate 1 or the like is essential, but gives rise to a problem that warpage or the like of the flexible substrate 1 itself has an influence on assembly accuracy. The configuration including the lens cover 21 makes it possible to minimize the influence of warpage or the like of the flexible substrate 1. The alignment with respect to the second missing part 23 is easily carried out. The member(s) contained in the lens cover 21 can be easily visually recognized and can be corrected by image recognition. For light-blocking purposes, a configuration may be employed in which a peripheral groove of the substrate holding member 4 is formed.

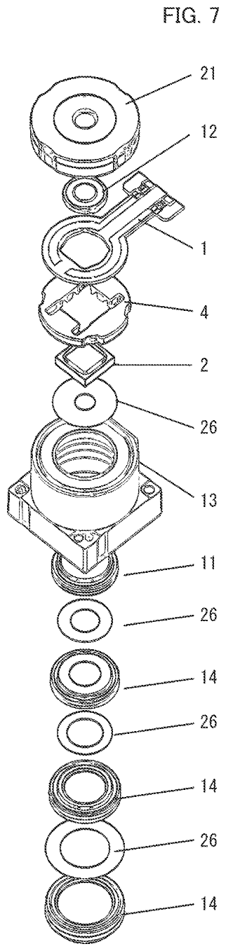

FIG. 7 is an exploded perspective view of the image pickup lens 51 in accordance with Embodiment 2 of the present disclosure. The image pickup lens 51 includes a light-blocking plate 26. The light-blocking plate 26 is a plate-like member that has a light-blocking function.

### Embodiment 3

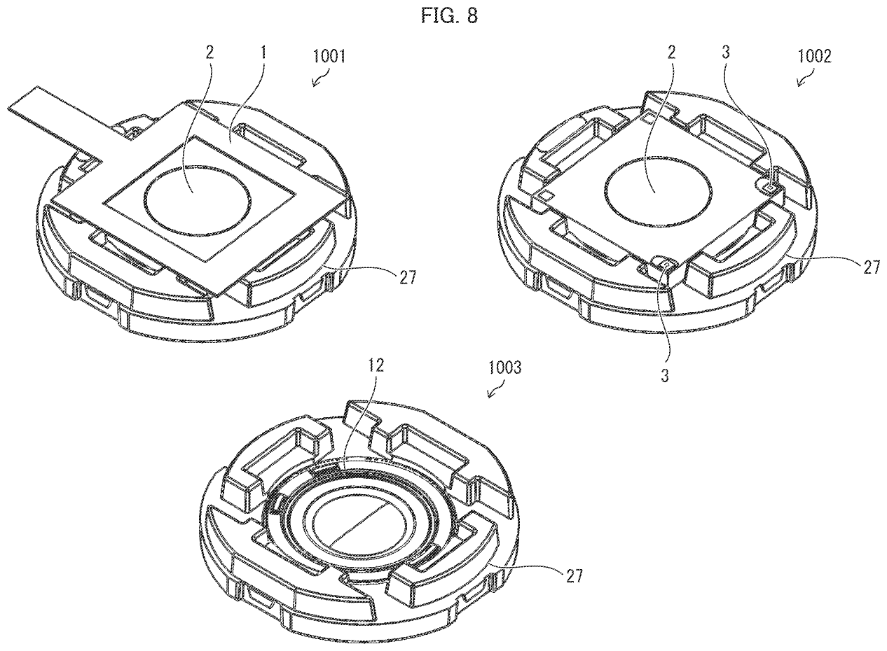

FIG. 8 is three perspective views each schematically illustrating a configuration of a substrate holding member-cum-lens cover 27 in accordance with Embodiment 3 of the present disclosure. In FIG. 8, the three perspective views respectively given reference numerals 1001 to 1003.

The substrate holding member-cum-lens cover 27 combines the function of the substrate holding member 4 and the function of the lens cover 21. According to FIG. 8, the image pickup lens 51 includes the second lens 12 that is located at a position closer to an object than the polymer lens 2, and the substrate holding member 4 may hold the second lens 12 in the form of the substrate holding member-cum-lens cover 27. This makes it possible to reduce the number of parts. In the present embodiment, the connection part 3 is a silver paste (electrically conductive paste).

Aspects of the present invention can also be expressed as follows:

An image pickup lens in accordance with a first aspect of the present disclosure includes: a flexible substrate having a first surface; a polymer lens provided with respect to the first surface; a connection part electrically connecting the flexible substrate and the polymer lens; and a substrate holding member holding the flexible substrate, the substrate holding member being fixed with respect to the first surface, the substrate holding member having an opening which is formed therein and in which the polymer lens and the connection part are located in a plan view.

According to the above-described configuration, in a case where the flexible substrate and the polymer lens are electrically connected to each other, the substrate holding member holds the flexible substrate. Thus, it is possible to reduce the risk that the connection part may come off from the flexible substrate or the polymer lens due to flection of the flexible substrate. Therefore, it is possible to realize an image pickup lens having high reliability.

In a second aspect of the present disclosure, the image pickup lens is configured, in the first aspect of the present disclosure, such that the substrate holding member contains a resin.

According to the above-described configuration, it possible to easily realize a substrate holding member.

In a third aspect of the present disclosure, the image pickup lens is configured, in the second aspect of the present disclosure, such that the resin is a liquid crystal polymer.

According to the above-described configuration, it is possible to impart excellent heat resistance to a substrate holding member. For example, in a case where the flexible substrate and the polymer lens are electrically connected to each other after the substrate holding member has been fixed with respect to the first surface, it is possible to reduce the risk of deformation of the substrate holding member.

In a fourth aspect of the present disclosure, the image pickup lens is configured, in any of the first to third aspects of the present disclosure, such that a side wall of the polymer lens and an inner wall which is of the substrate holding member and which defines the opening are bonded to each other.

According to the above-described configuration, it is possible to fix the polymer lens and the substrate holding member. Thus, it is possible to realize an image pickup lens having higher reliability.

In a fifth aspect of the present disclosure, the image pickup lens is configured, in the fourth aspect of the present disclosure, such that the side wall and the inner wall are bonded to each other at a plurality of bonding portions, and the plurality of bonding portions are located so as to be rotationally symmetric with respect to a center of the polymer lens in a plan view.

The above-described configuration provides a tolerance to a positional deviation of the polymer lens in a direction of rotation of the polymer lens in a plan view.

In a sixth aspect of the present disclosure, the image pickup lens is configured, in any of the first to fifth aspects of the present disclosure, to include a first lens located at a position closer to an image-forming plane than the polymer lens; and a lens barrel accommodating the first lens, wherein the flexible substrate and an outer wall of the lens barrel are engaged with each other.

According to the above-described configuration, it is possible to position the flexible substrate. Thus, it is possible to reduce the risk of assembly failure resulting from interference of the flexible substrate with other member (e.g., a rigid flexible substrate) during the production of a camera module.

In a seventh aspect of the present disclosure, the image pickup lens is configured, in the sixth aspect of the present disclosure, such that the outer wall has a projected part that is fitted into a first missing part which is formed in the flexible substrate.

According to the above-described configuration, it is possible to easily realize an engagement structure between the flexible substrate and the outer wall of the lens barrel.

In an eighth aspect of the present disclosure, the image pickup lens is configured, in any of the first to seventh aspects of the present disclosure, to include: a second lens located at a position closer to an object than the polymer lens and having a lens surface on a side thereof on which the object is present; and a lens cover covering an outer region of the lens surface, wherein the flexible substrate is drawn from an inside of the lens cover to an outside of the lens cover in the plan view at a second missing part that is formed in the lens cover.

According to the above-described configuration, it is possible to apply a voltage to a flexible substrate in a state in which physical load on the flexible substrate is small. Thus, it is possible to reduce the risk of deterioration in the optical characteristic (e.g., light blocking by the flexible substrate and difficulty in optical correction) resulting from deformation of the flexible substrate.

In a ninth aspect of the present disclosure, the image pickup lens is configured, in the eighth aspect of the present disclosure, such that the lens cover has a covering part covering the outer region of the lens surface and a wall part extending from the covering part toward an image-forming plane, and the second missing part is formed in the wall part and has an object-side end portion that is defined by the covering part.

According to the above-described configuration, any step is not formed on an image-forming plane side of the covering part. Thus, it is possible to further reduce physical load on the flexible substrate.

In a tenth aspect of the present disclosure, the image pickup lens is configured, in any of the first to ninth aspects of the present disclosure, to include a second lens located at a position closer to an object than the polymer lens, wherein the substrate holding member holds the second lens.

According to the above-described configuration, it is possible to reduce the number of parts.

In an eleventh aspect of the present disclosure, the image pickup lens is configured, in any of the first to tenth aspects of the present disclosure, such that the connection part is one selected from the group consisting of a bonding wire and an electrically conducive paste.

According to the above-described configuration, it possible to easily realize a connection part.

A camera module in accordance with a twelfth aspect of the present disclosure includes: the image pickup lens; and an image pickup element that receives light having passed through the image pickup lens.

A method for producing an image pickup lens in accordance with a thirteenth aspect includes: fixing, with respect to a first surface of a flexible substrate, a substrate holding member having an opening formed therein and providing a polymer lens with respect to the first substrate so that the polymer lens is located in the opening in a plan view; and electrically connecting the flexible substrate and the polymer lens in the opening in the plan view.

According to the above-described configuration, it is possible to produce the image pickup lens.

In a fourteenth aspect of the present disclosure, the method for producing an image pickup lens is configured, in the thirteenth aspect of the present disclosure, such that the substrate holding member containing a liquid crystal polymer is formed, and, after the substrate holding member has been fixed with respect to the first surface of the flexible substrate, the flexible substrate and the polymer lens are electrically connected to each other.

According to the above-described configuration, it is possible to reduce the risk of deformation of the substrate holding member while the flexible substrate is held by the substrate holding member as quickly as possible.

The present disclosure is not limited to the above-described embodiments, but can be altered by a skilled person in the art within the scope of the claims. The present disclosure also encompasses, in its technical scope of the present disclosure, any embodiment derived by combining technical means disclosed in differing embodiments. Further, a novel technical feature can be created by a combination of technical means disclosed in these embodiments.

### REFERENCE SIGNS LIST

1: flexible substrate
2: polymer lens
3: connection part
4: substrate holding member
5: first surface
6: opening
7: side wall of polymer lens
8: inner wall defining the opening in the substrate holding member
9: bonding portions
10: center of polymer lens
11: first lens
12: second lens
13: lens barrel
14: third lens
15: outer wall of the lens barrel
16: rigid flexible substrate
17: rigid part
18: flexible part
19: first missing part
20: projected part
21: lens cover
22: lens surface
23: second missing part
24: covering part
25: wall part
26: light-blocking plate
27: substrate holding member-cum-lens cover
28: frame
29: lens surface
30: abutting portion
51: image pickup lens
52: image pickup element
53: cover glass
101: camera module

1. An image pickup lens comprising:
a flexible substrate having a first surface;
a polymer lens provided with respect to the first surface;
a connection part electrically connecting the flexible substrate and the polymer lens; and
a substrate holding member holding the flexible substrate,
the substrate holding member being fixed with respect to the first surface,
the substrate holding member having an opening which is formed therein and in which the polymer lens and the connection part are located in a plan view.

2. The image pickup lens according to claim 1, wherein the substrate holding member contains a resin.

3. The image pickup lens according to claim 2, wherein the resin is a liquid crystal polymer.

4. The image pickup lens according to claim 1, wherein a side wall of the polymer lens and an inner wall which is of the substrate holding member and which defines the opening are bonded to each other.

5. The image pickup lens according to claim 4, wherein
the side wall and the inner wall are bonded to each other at a plurality of bonding portions, and
the plurality of bonding portions are located so as to be rotationally symmetric with respect to a center of the polymer lens in a plan view.

6. The image pickup lens according to claim 1, comprising:
a first lens located at a position closer to an image-forming plane than the polymer lens; and
a lens barrel accommodating the first lens, wherein
the flexible substrate and an outer wall of the lens barrel are engaged with each other.

7. The image pickup lens according to claim 6, wherein the outer wall has a projected part that is fitted into a first missing part which is formed in the flexible substrate.

8. The image pickup lens according to claim 1, comprising:
a second lens located at a position closer to an object than the polymer lens and having a lens surface on a side thereof on which the object is present; and
a lens cover covering an outer region of the lens surface, wherein
the flexible substrate is drawn from an inside of the lens cover to an outside of the lens cover in the plan view at a second missing part that is formed in the lens cover.

9. The image pickup lens according to claim 8, wherein
the lens cover has a covering part covering the outer region of the lens surface and a wall part extending from the covering part toward an image-forming plane, and
the second missing part is formed in the wall part and has an object-side end portion that is defined by the covering part.

10. The image pickup lens according to claim 1, comprising a second lens located at a position closer to an object than the polymer lens, wherein
the substrate holding member holds the second lens.

11. The image pickup lens according to claim 1, wherein the connection part is one selected from the group consisting of a bonding wire and an electrically conducive paste.

12. A camera module comprising:
the image pickup lens according to claim 1; and
an image pickup element that receives light having passed through the image pickup lens.

13. A method for producing an image pickup lens, comprising:
fixing, with respect to a first surface of a flexible substrate, a substrate holding member having an opening formed therein and providing a polymer lens with respect to the first substrate so that the polymer lens is located in the opening in a plan view; and
electrically connecting the flexible substrate and the polymer lens in the opening in the plan view.

14. The method according to claim 13, wherein
the substrate holding member containing a liquid crystal polymer is formed, and
after the substrate holding member has been fixed with respect to the first surface of the flexible substrate, the flexible substrate and the polymer lens are electrically connected to each other.
